(19) United States
(12) Patent Application Publication
(10) Pub. No.: US 2005/0166328 A1
(43) Pub. Date: Aug. 4, 2005

(54) Automatic patient turner

(75) Inventor: Michael Ben-Levi, Los Angeles, CA (US)

Correspondence Address: Michael Ben-Levi, 104 South Hayworth Avenue, #202, Los Angeles, CA, 90048, US

(73) Assignee: Tumamatic Foundation

(21) Appl. No.: 11/075,259

(22) Filed: Mar. 8, 2005

Related U.S. Application Data
(63) Continuation-in-part of application No. 10/165,703, filed on Jun. 8, 2002, now abandoned.

(51) Int. Cl. A61G 7/057; A61G 7/015

(52) U.S. Cl. 5/715; 5/615

(57) ABSTRACT

The Automatic Patient Turner is the ultimate in pressure sore prevention by automatically, periodically, and alternately tilting, and then laterally turning an immobile patient 180 degrees, from one complete side to the other in a manner similar to but gentler and less intrusive than manual turning. This is accomplished by the patterned, sequential inflation and deflation of six strategically placed inflatables. When sandwiched between a pair of knee inflatables, the bent knees act as a lever arm in the turning process. The inflation of an elongated inflatable beneath the flexible mattress raises that longitudinal side causing the bent knees to move from a perpendicular position to a 120° angle. Due to the force of gravity, the bent knees descend laterally in the direction of the turn as the knee inflatables deflate. The descending knees pull the entire body completely to the side of the turn as a back-support pillow inflates.

This application is a continuation-in-part of application Ser. No. 10/165,703 filed on Jun. 8, 2002.

### FIELD

The Automatic Patient Turner is an encased flexible mattress assembly that will laterally tilt an immobile patient automatically, and periodically along the longitudinal axis of a hospital bed, and then continue to gently turn the patient laterally 180 degrees, from one complete side to the other. It is designed to prevent pressure sores as well as an accumulation of fluid in the lungs. The former condition may lead to a systemic blood infection and the latter to pneumonia. Should either of these two conditions become serious, it could be fatal.

In the United States Manual of Patent Classifications, this invention falls under the following two class/subclasses: 5/615, “fluid inflatable bag adjusts position of support section,” and 5/607, “tiltable along a longitudinal axis.” The International Patent Classification is A61G 7/00, a “means for displacing patients or invalids.”

### BACKGROUND OF THE INVENTION

Pressure sores and the accumulation of fluid in the lungs have always been endemic among immobile patients. Both disabilities develop when an immobile patient remains in one position for prolonged periods of time. Aside from causing considerable pain to the patient, pressure sores are difficult and costly to treat. There is a consensus among wound care specialists that pressure sores are preventable if the patient is repositioned at least every two hours as is mandated by current regulations. Manually turning an immobile patient every two hours around the clock by a nurse or a caregiver is very demanding. Recent studies have reported that at the current level of staffing, many immobile patients in American long-term care nursing facilities are often left to remain in one position for up to four hours. To accommodate existing and realistic staffing practices, an ideal solution to that problem would be to find an automatic, mechanical device for repositioning a patient as effectively as the manual turning by a nurse.

In response to the need to find an automatic, mechanical device that would reposition an immobile patient, a number of inventions that tilt a patient from side to side have been patented. Each of the eight inventions that are cited below tilts a patient, as does the present invention, by utilizing right and left elongated inflatables to laterally raise alternate longitudinal sides of the surface upon which the patient lies.

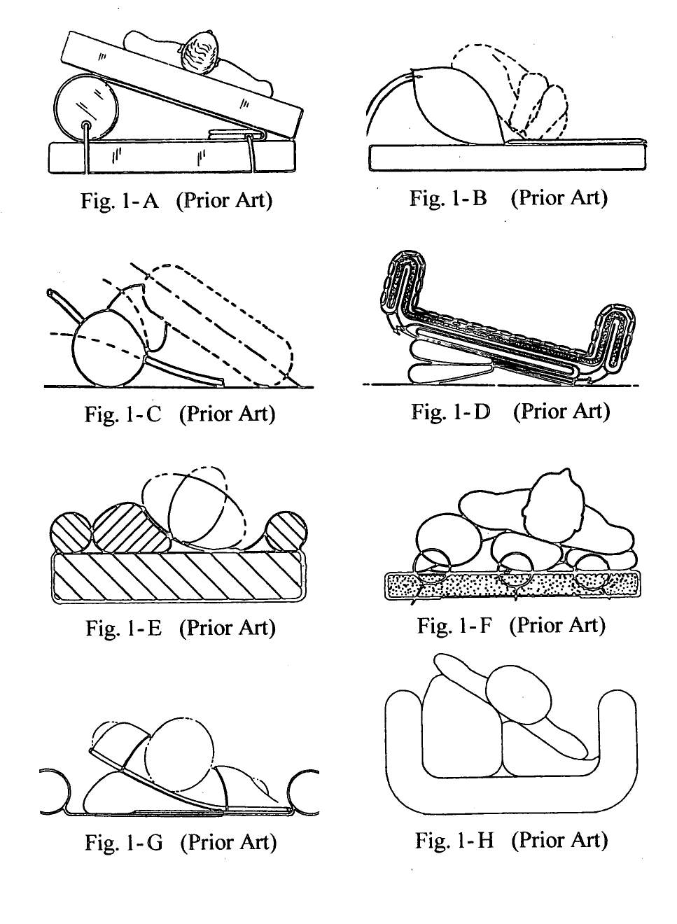

In FIG. 1-A through FIG. 1-H, a drawing from each of these eight rotational inventions shows the angle of incline and method used in tilting a patient. The slope of the angles ranges from approximately 15 to 32 degrees. The following eight prior art drawings are listed in chronological order.

FIG. 1-A—U.S. Pat. No. 3,717,885, Feb. 27, 1973, De Mare, “Clinical Manipulator.”

FIG. 1-B—U.S. Pat. No. 3,775,781, Dec. 4, 1973, Bruno et al., “Patient Turning Apparatus.”

FIG. 1-C—U.S. Pat. No. 3,895,403, Jul. 22, 1975, Davis, “Patient Orienting Device.”

FIG. 1-D—U.S. Pat. No. 4,934,002, Jun. 19, 1990, Watanabe, “Tiltable Mat Assembly.”

FIG. 1-E—U.S. Pat. No. 5,092,007, Mar. 3, 1992, Hasty, “Air Mattress Overlay for Lateral Patient Roll.”

FIG. 1-F—U.S. Pat. No. 5,121,512, Jun. 16, 1992, Kaufmann, “Auxiliary Inflatable Device Serving Mattress.”

FIG. 1-G—U.S. Pat. No. 6,154,900, Dec. 5, 2000, Shaw, “Patient Turning Apparatus.”

FIG. 1-H—U.S. Pat. No. 6,253,402, Jun. 3, 2001, Lin, “Air Bed Structure Capable of Lying Thereon on Either of One's Sides.”

While these eight rotational devices perform essentially the same function, they do differ in some degree. In De Mare's “Clinical Manipulator,” FIG. 1-A, the patient lies upon a rigid hospital bed mattress. In Watanabe's “Tiltable Mat Assembly,” FIG. 1-D, the patient lies upon a non-flexible cradle-like mat assembly. In each of the other six inventions, the patient lies directly or almost directly upon the inflatables. In contrast, the patient in the present invention lies upon a flexible mattress. This difference, however, is not the crucial variable completely differentiating the Automatic Patient Turner from the prior art.

After being tilted, the patient in each of the eight inventions cited above continually lies at an incline until tilted to the other side. In terms of repositioning, tilting a patient is certainly better than having a patient continually lie upon a stationary horizontal surface. Currently, there are on the market a number of rotational air mattresses that can tilt a patient to alternately lie on an approximate 30° incline. Some are alternating pressure mattresses, others are low air loss mattresses, and there are those that have incorporated both features in their tiltable mattresses. In each of these devices, the patient lies on a slope along the center longitudinal axis of the bed with his or her body and legs in a straight line until tilted to the other side.

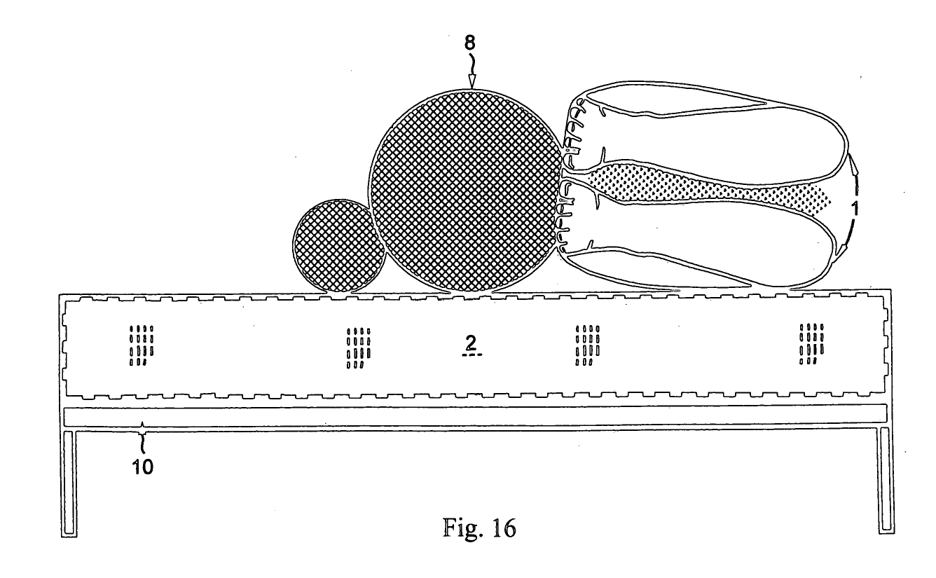

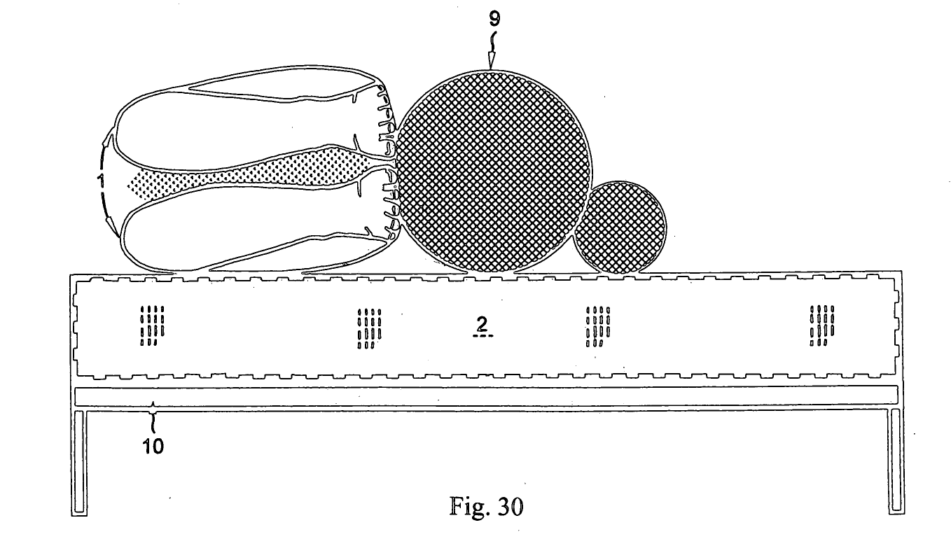

Optimum repositioning would entail not just the alternate tilting of a patient. Ideally, it would require the alternate turning of an immobile patient 180 degrees, from one complete side to the other, in a manner similar to the manual turning by a nurse or caregiver. The present invention accomplishes this. The patient in the Automatic Patient Turner is tilted at a 30° incline as an initial phase in the turning process. The patient is then completely turned to one side so as to lie upon a horizontal mattress with a pillow between the bent knees and legs, and an encased inflatable ‘pillow’ lending support to the patient's back. Except for the turning process that takes less than three minutes, the patient in the Automatic Patient Turner lies either on one side or the other. When a patient lies on his or her side, there is no pressure on the back, buttocks, or heels, the three areas on the body where pressure sores are more likely to develop; see FIGS. 16 and 30.

The salient feature of the Automatic Patient Turner that totally differentiates it from the eight patented devices cited above, and from any similar patient tilting device, is the use of the patient's bent knees sandwiched between at least one pair of encased knee inflatables. The bent knees serve as a lever arm in the turning process. It is this innovative and unique feature of the present invention that makes it technically possible to turn a patient completely to one side from a tilt position.

Unlike manual turning that invariably wakes a patient, the automatic turn by the Automatic Patient Turner is so slow, gentle and non-intrusive, it will not wake the average sleeping patient. The immobile patient will then be able to have a full night of uninterrupted sleep, an important factor in the well being of the patient.

Since the present invention will gently turn a patient from one complete side to the other every hour, and the prototype has incorporated both an alternating pressure and low air loss features in its encased flexible mattress assembly, it would not be an overstatement to say that the Automatic Patient Turner is the ultimate in pressure sore prevention, as well as significantly lessening the probability of an immobile patient contracting pneumonia from an accumulation of fluid in his or her lungs.

### REFERENCE NUMERALS USED IN THE DRAWINGS

For ready reference, the following is a numerical list of each part shown in the drawings and mentioned in both the disclosure and claims. Not only is each part listed, but its function and role in the operation of the invention is delineated. In specifying the number of inflatables at each location, the sections titled “BACKGROUND OF THE INVENTION,” “REFERENCE NUMERALS USED IN THE DRAWING,” “A BRIEF DESCRIPTION OF THE INVENTION,” as well as the “CLAIMS” all state “at least one.” However, for simplicity and clarity, in the section titled “A LIST OF THE DRAWINGS OF THE PRESENT INVENTION,” and “A DETAILED DESCRIPTION OF THE INVENTION,” the number of inflatables at each location is based on the prototype of the invention where only one inflatable was used at each location. Furthermore, the use of the terms ‘right’ and ‘left’ are from the perspective of the patient lying in bed.

It should be pointed out that each encased knee and encased back-support inflatable is a two-part inflatable comprising a main section and a pneumatically attached companion inflatable that acts as a bolster. The purpose of the companion bolster is to lend support to the main inflatable, ensuring that it will remain in a perpendicular position when the bolster is fully inflated.

The following is a numerical list of the ten parts included in the drawings and mentioned in both the disclosure and claims.

[1]—Bent knees of the patient. They are shown in the drawings at different angles during the turning process, indicating the changing position of the patient. The bent knees [1] act as a lever arm in the turning process.

[2]—Flexible mattress. The flexible mattress [2] is located immediately under the top waterproof covering that encases it. Flexibility is important so that one longitudinal side of the flexible mattress [2] can be raised to a lateral incline while the other longitudinal side of the mattress remains in a horizontal position. Immediately beneath the flexible mattress [2], and along each longitudinal side are encased elongated inflatables [4 and 5].

[3]—Chamber for the encased elongated inflatables. Also encased within the flexible mattress assembly is a chamber [3], which is the space between the flexible mattress and the inside bottom of the encased flexible mattress assembly. The chamber [3] houses at least one encased right elongated inflatable [4] and at least one encased left elongated inflatable [5]. Each are placed beneath and along its respective longitudinal side of the flexible mattress [2].

[4]—Right encased elongated inflatable(s). At least one is located in the chamber [3] beneath the right longitudinal side of the flexible mattress [2]. When an encased right elongated inflatable [4] is inflated, it raises the right longitudinal side of the flexible mattress [2].

[5]—Left encased elongated inflatable(s). At least one is located in the chamber [3] beneath the left longitudinal side of the flexible mattress [2]. When an encased left elongated inflatable [5] is inflated, it raises the left longitudinal side of the flexible mattress [2].

[6]—Encased right knee inflatable(s) with bolster. At least one is located and attached to the top of the encased flexible mattress assembly on the right side of the patient's bent knees [1]. In conjunction with the inflation and deflation of an encased left knee inflatable [7], these encased knee inflatables [6 and 7] guide the bent knees [1] in the direction of the turn.

[7]—Encased left knee inflatable(s) with bolster. At least one is located and attached to the top of the encased flexible mattress assembly on the left side of the patient's bent knees [1]. In conjunction with the inflation and deflation of an encased right knee inflatable [6], these encased knee inflatables [6 and 7] guide the bent knees [1] in the direction of the turn.

[8]—Encased right back-support inflatable(s) with bolster. At least one is located and attached to the top of the encased flexible mattress assembly on the right side of the patient's back. While an encased right back-support inflatable ‘pillow’ [8] inflates, it pushes the right side of the patient's back in the direction of turning left, ensuring that the back is on the same incline as the bent knees [1]. Upon the completion of a turn to the left, at least one encased right back-support inflatable ‘pillow’ [8] continues to remain inflated to lend support to the right side of the patient's back while the patient is lying on the left side. Approximately an hour later, when the patient is returning to the right side, the support given by the encased right back-support inflatable ‘pillow’[8] gradually diminishes as it deflates.

[9]—Encased left back-support inflatable(s) with bolster. At least one is located and attached to the top of the encased flexible mattress assembly on the left side of the patient's back. While an encased left back-support inflatable ‘pillow’ [9] is inflating, it pushes the left side of the patient's back in the direction of turning right, ensuring that the back is on the same incline as the bent knees [1]. Upon the completion of the turn to the right, at least one encased left back-support inflatable ‘pillow’ [9] continues to remain inflated to lend support to the left side of the patient's back while the patient is lying on the right side. Approximately an hour later, when the patient is returning to the left side, the support given by the encased left back-support inflatable ‘pillow’[9] gradually diminishes as it deflates.

[10]—Hospital bed. The encased flexible mattress assembly is placed upon it. Since the width of the encased flexible mattress assembly used in the prototype is wider than a regular hospital bed mattress, a wider hospital bed or attachments to widen a regular size hospital bed will be necessary.

Not shown in any of the drawings is the tubing that connects the inflatables to the control box containing the equipment that operates the system. Among the major items in the control box are at least one microprocessor, a circuit board, compressors with pressure and vacuum ports, solenoid valves, pressure and vacuum switches, sensors, and an isolation transformer.

The control panel is also not shown in any of the drawings. Among the items on the panel are the following switches: power, off/on, automatic turn, non-automatic turn, right turn, left turn, tilt right, tilt left, flat, reset, and monitor. Also on the panel are LEDs, an LCD or a similar display, and a beeper. The sound of a beeper and the blinking light in the reset push button are designed to alert the nurse or caregiver to read the message on the display. To acknowledge having read the message, the nurse or caregiver is to clear the message by pressing the blinking, lighted reset push button that will then terminate the blinking and the beeping.

### A BRIEF DESCRIPTION OF THE INVENTION

Being wider than a regular hospital bed mattress, the flexible mattress assembly is to be placed upon a hospital bed [10] of sufficient width to accommodate it. A flexible mattress [2] is encased in the flexible mattress assembly. The type of flexible mattress [2] may include a foam mattress, a flexible alternating pressure air mattress, a flexible low air loss mattress, a flexible mattress combining both of those features, or any flexible mattress. Beneath the flexible mattress [2] is a chamber [3] that houses at least one encased right elongated inflatable [4] along and under the right longitudinal side of the flexible mattress [2], and the chamber [3] also houses at least one encased left elongated inflatable [5] along and under the left longitudinal side of the flexible mattress [2]. Each encased elongated inflatable [4 or 5] is securely attached to the inner bottom surface of its respective longitudinal side of the encased flexible mattress assembly. The alternate inflation and deflation of at least one encased right or at least one encased left elongated inflatable [4 or 5] will raise its respective longitudinal side of the flexible mattress [2]. Being flexible, the raised longitudinal side of the flexible mattress [2] will form a gentle curve with the other longitudinal side of the flexible mattress [2] that has remained in a horizontal position. The raising of a longitudinal side of the flexible mattress [2] will tilt the patient on an incline as the first phase of the turning process.

There are at least four different locations on the top surface of the encased flexible mattress assembly where encased inflatables are securely attached. (1) At least one encased knee inflatable [6] is located on the outer right side of the patient's bent knees [1]. (2) At least one encased knee inflatable [7] is located on the outer left side of the patient's bent knees [1]. (3) At least one encased back-support inflatable ‘pillow’ [8] is positioned along the right side of the patient's back. (4) At least one encased back-support inflatable ‘pillow’ [9] is positioned along the left side of the patient's back.

The patterned, sequential inflation and deflation of at least six strategically placed inflatables, an integral part of the encased flexible mattress assembly, will initially tilt the patient laterally, and then continue to laterally turn the patient to lie on one side and later turn to lie on the other side. The utilization of the bent knees [1] of the patient is the crucial variable that makes it possible to turn a patient completely from one side to the other. Sandwiched between at least one pair of encased knee inflatables [6 and 7], the bent knees [1] of the patient act as a lever arm in the turning process. These encased knee inflatables [6 and 7] gently guide the bent knees [1] in turning the patient right or left as these inflatables [6 and 7] inflate and/or deflate either together or at times separately.

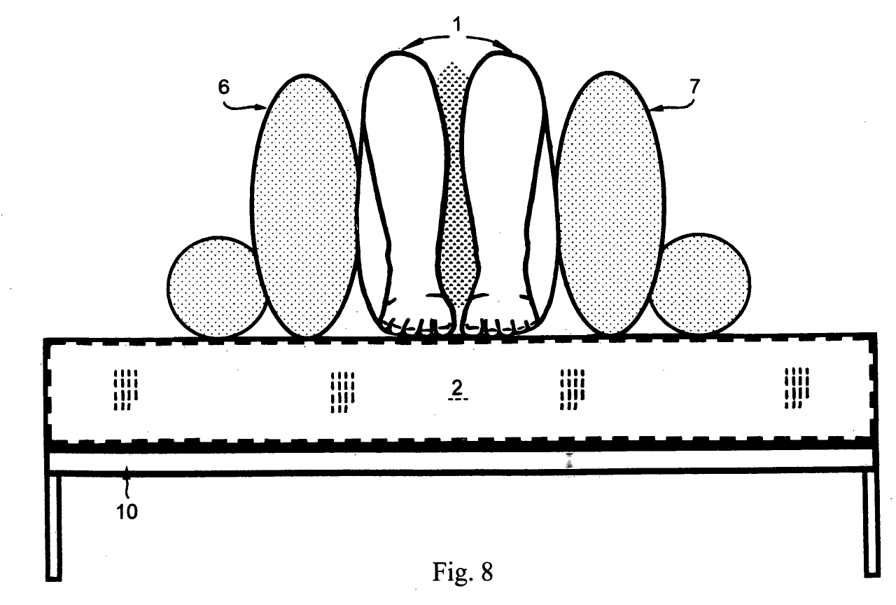

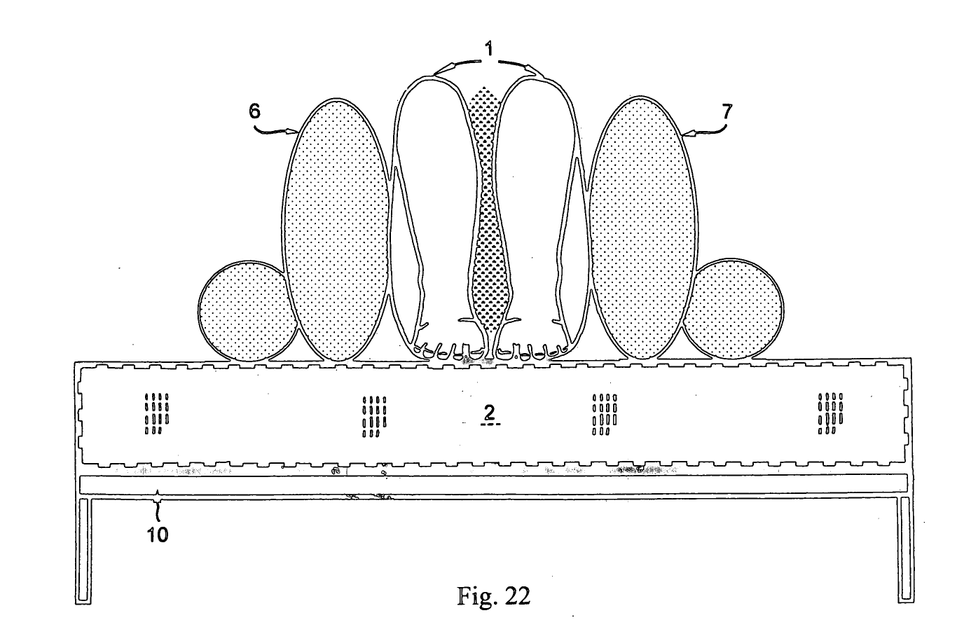

To start the turning process, the patient is to lie along the center longitudinal axis of the hospital bed [10] with the knees of the patient raised and held in a perpendicular position by a nurse or caregiver. The knees are bent forming the apex of an inverted V, and a pillow is placed between the bent knees and legs. The nurse or caregiver is to continue holding the bent knees [1] in a perpendicular position as at least one encased right knee inflatable [6] and at least one encased left knee inflatable [7] inflate at the same time. When the encased knee inflatables [6 and 7] are fully inflated, the bent knees [1] are ‘locked in place’ by being sandwiched between the fully inflated encased knee inflatables [6 and 7]; see FIGS. 8 and 22.

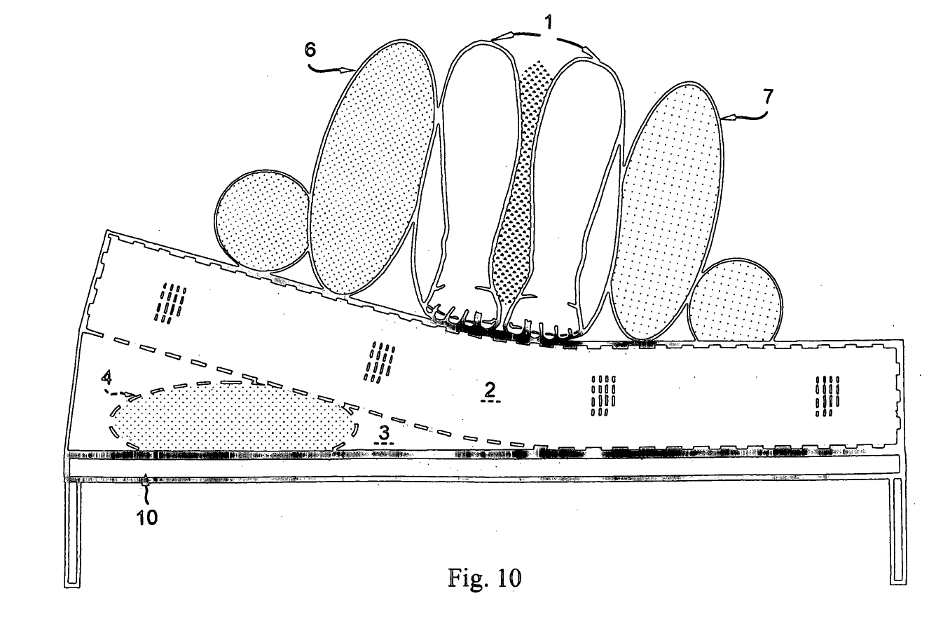

The inflation of at least one encased elongated inflatable [4 or 5] beneath and along one longitudinal side of the flexible mattress [2] will raise that side of the flexible mattress [2]. At the same time, on that same longitudinal side of the flexible mattress [2], at least one encased back-support inflatable ‘pillow’ [8 or 9] will also inflate. As that longitudinal side of the flexible mattress [2] is raised due to the inflation of at least one encased elongated inflatable beneath it [4 or 5], the bent knees [1] that were initially in a perpendicular position and sandwiched between at least one pair of fully inflated encased knee inflatables [6 and 7] now begin to move in the direction of the turn; see FIGS. 10, and 11 and FIGS. 24 and 25.

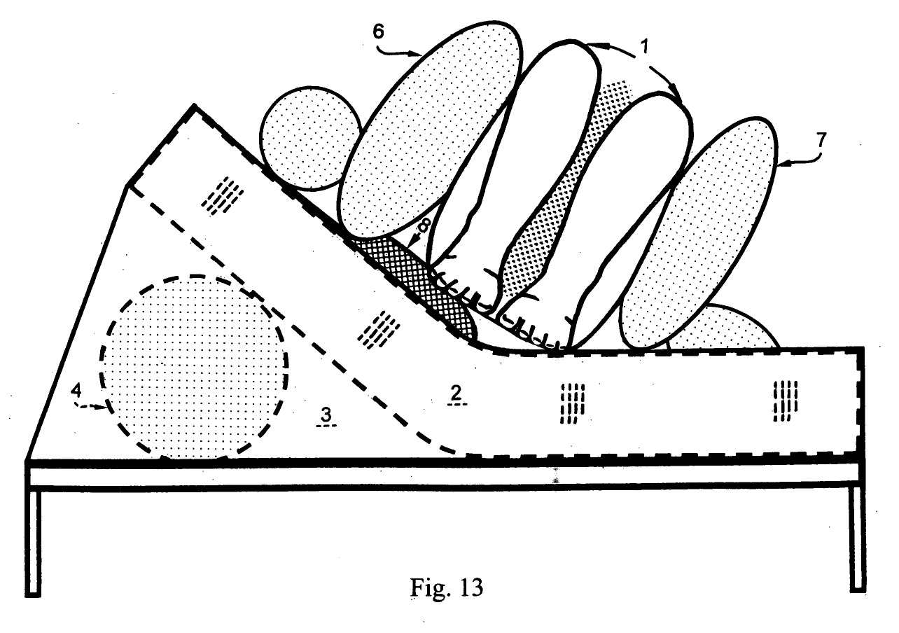

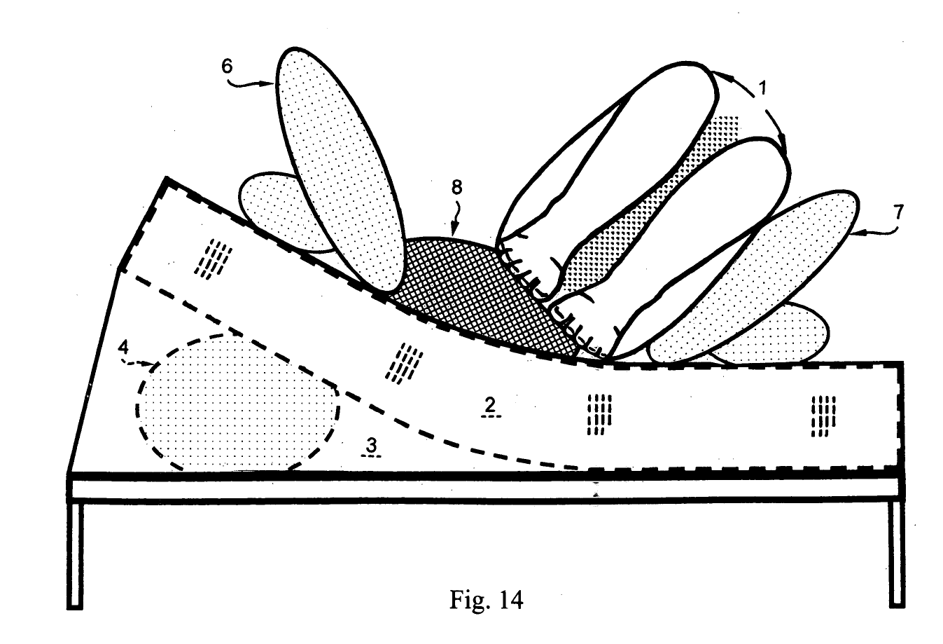

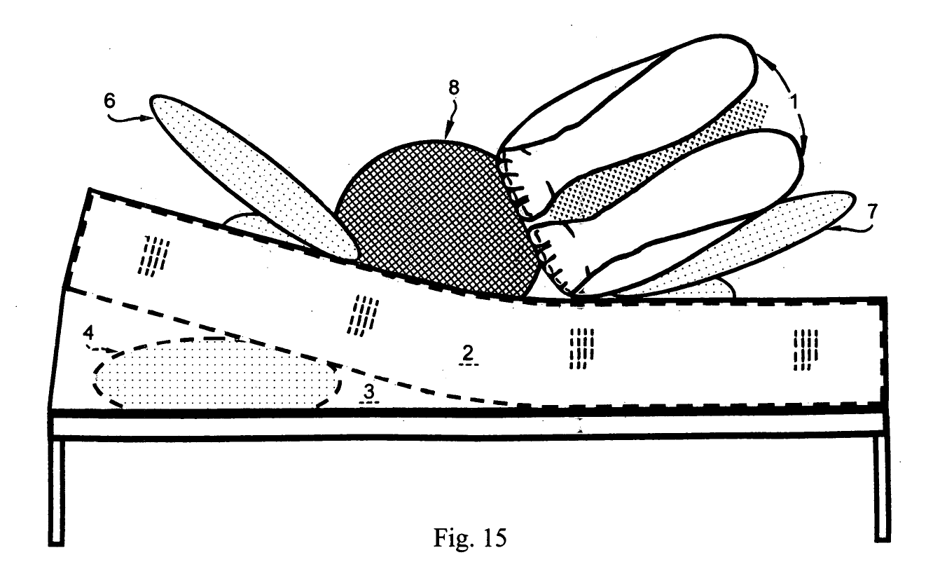

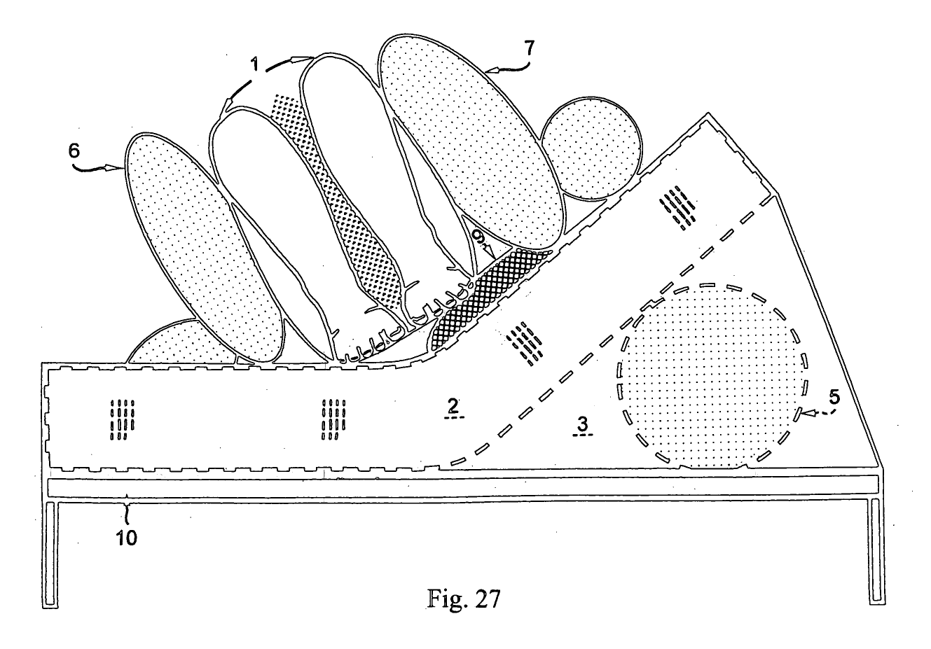

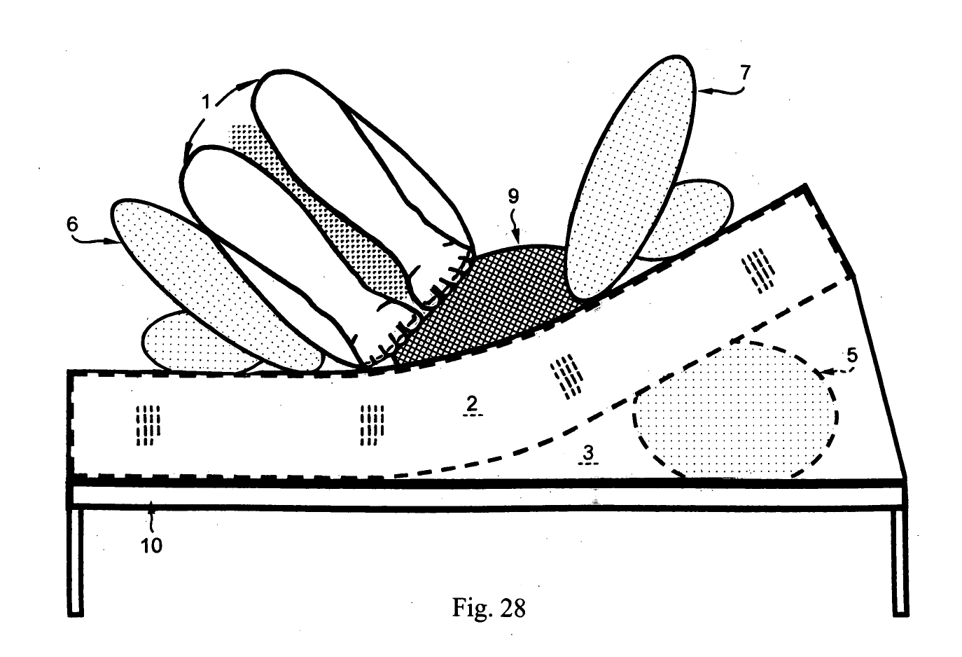

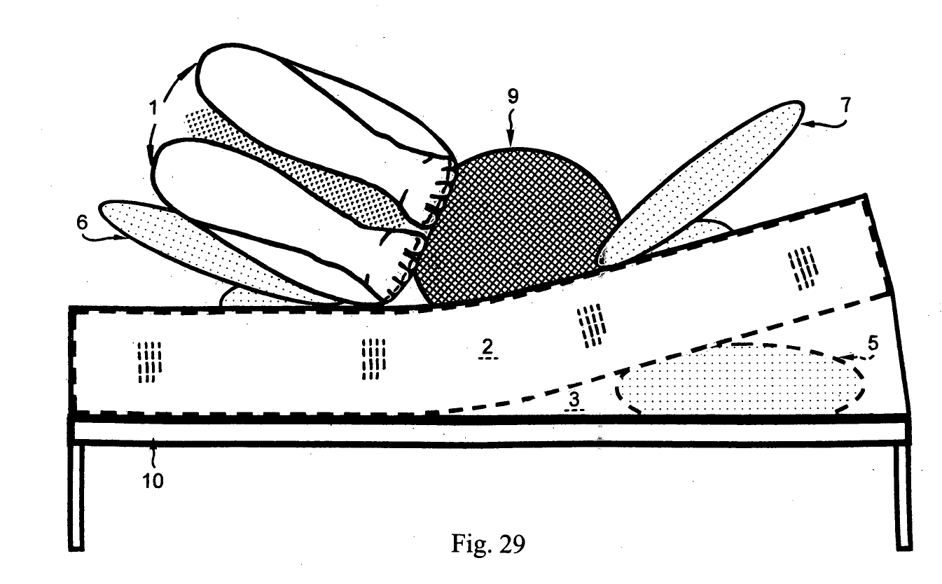

Once the bent knees [1] have moved to a point where they are 30 degrees beyond their initial perpendicular position, the fully inflated encased elongated inflatable [4 or 5] and the encased knee inflatables [6 and 7] will now gradually deflate; see FIGS. 13 and 27. The bent knees [1] will continue to descend due to the force of gravity and the gradual deflation of the encased knee inflatable [6 or 7] upon which the bent knees [1] are resting. As at least one encased back-support inflatable [8 or 9] that was already in the process of inflation continues to gradually inflate, it will gradually ‘push’ the back of the patient in the direction of the turn, ensuring that the back is on the same incline as the descending bent knees [1]; see FIGS. 14 and 15; FIGS. 28 and 29. At the end of the turning process, the encased elongated inflatable [4 or 5] and the encased knee inflatables [6 and 7] that had been inflated are now fully deflated. The patient is now completely turned to one side to lie upon the flexible mattress [2] that is now in a horizontal position, with at least one encased back-support fully inflated ‘pillow’ [8 or 9] lending support to the patient's back; see FIGS. 16 and 30.

The Automatic Patient Turner gently turns a patient in a manner similar to the manual turning by a nurse or caregiver. The patient will lie upon a flat mattress with a pillow between the bent knees and legs, and an inflatable pillow lending support to the back of the patient. Since one hour is the optimum amount of time a patient should remain in any one position, the patient in the Automatic Patient Turner will be completely turned every hour from one side to the other.

### LISTING OF THE DRAWINGS OF THE PRESENT INVENTION

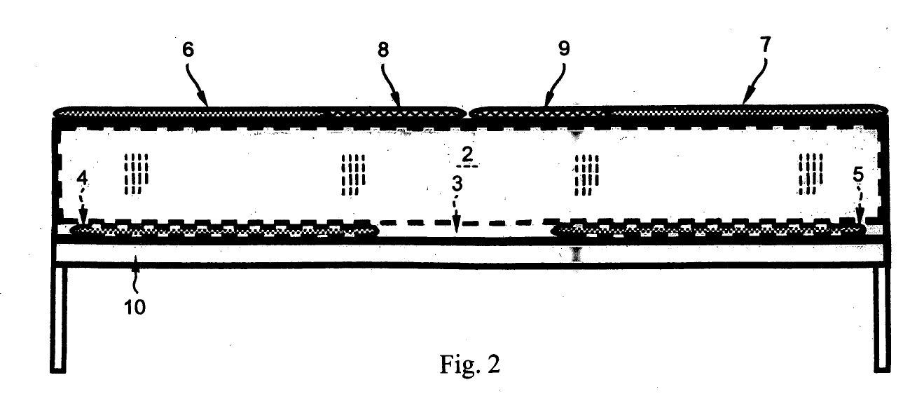

FIG. 1-A through FIG. 1-H are prior art drawings, while FIG. 2 through FIG. 30 relate to the present invention. Two distinct patterns are used to differentiate the inflatables that appear in the 29 drawings of the current invention. The two encased elongated inflatables [4 and 5] located beneath the flexible mattress [2] and the two encased knee inflatables [6 and 7] attached to the top of the encased flexible mattress assembly are shown with a dot pattern, while the two encased back-support inflatables [8 and 9] that are also attached to the top of the encased flexible mattress assembly have a criss-cross pattern.

The density of the dot pattern or criss-cross pattern distinguishes whether or not an inflatable is in the process of inflation or fully inflated, or if the inflatable is in the process of deflation. A denser pattern denotes inflation, while a less dense pattern indicates that the inflatable is in the process of deflation.

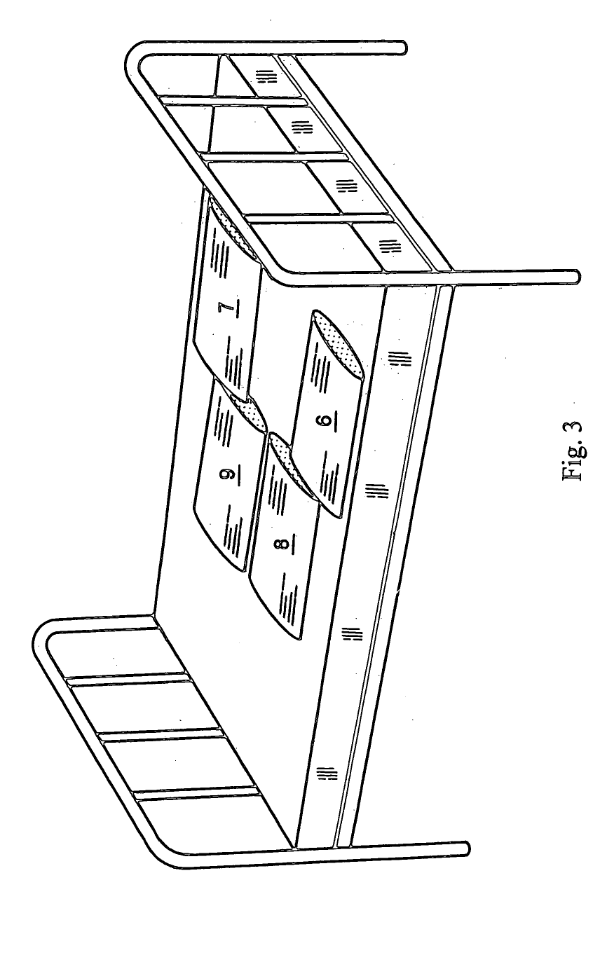

All of the 29 figures, except for FIG. 3, are foot-of-the-bed views of the encased flexible mattress assembly. The flexible mattress [2] and the encased elongated inflatables [4 and 5] are all encased within a waterproof covering; therefore, they are not visible. Those parts, however, are viewed in the drawings by the use of broken lines.

FIG. 2: A foot-of-the-bed view of the encased flexible mattress assembly showing the location of six inflatables fully deflated. When deflated, an inflatable is thin, flat, and not very noticeable. In FIG. 2, however, the thickness of the six deflated inflatables has been greatly exaggerated so that their location can be readily noted. In all of the other drawings, a fully deflated inflatable will not be depicted.

FIG. 3: A right-side view of the encased flexible mattress assembly showing the location of the encased right and encased left knee inflatables [6 and 7], and the encased right and encased left back-support inflatables [8 and 9], all located and securely attached to the top of the encased flexible mattress assembly. The encased right and encased left knee inflatables [6 and 7] and the encased right and encased left back-support inflatables [8 and 9], shown in FIG. 3, are seen semi-inflated for illustration purposes. While both the encased right and encased left knee inflatables [6 and 7] are at times inflated and deflated simultaneously, the encased back-support inflatables [8 and 9] are prevented from ever being inflated at the same time.

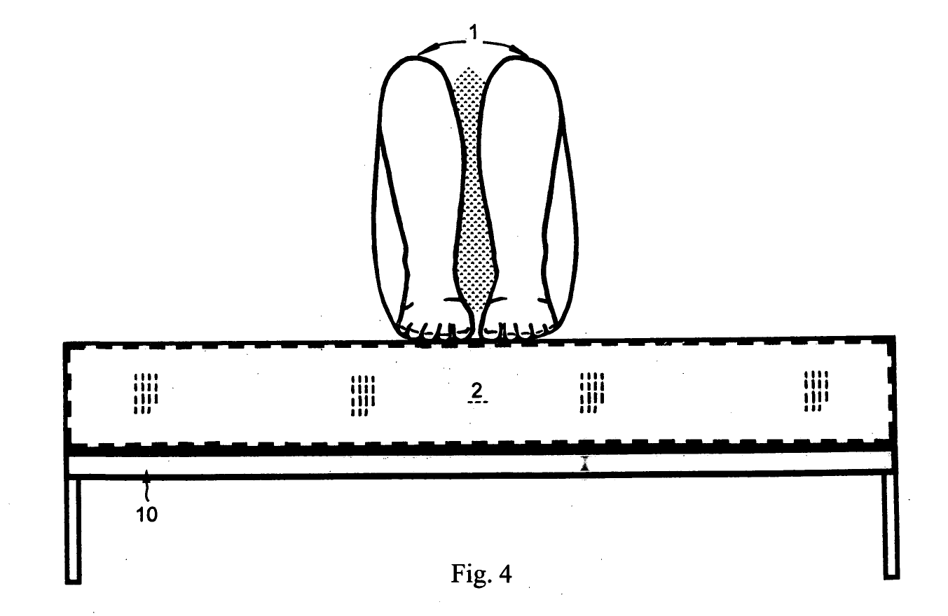

FIG. 4: A patient lying along the center longitudinal axis of the hospital bed with bent knees [1] in a perpendicular position.

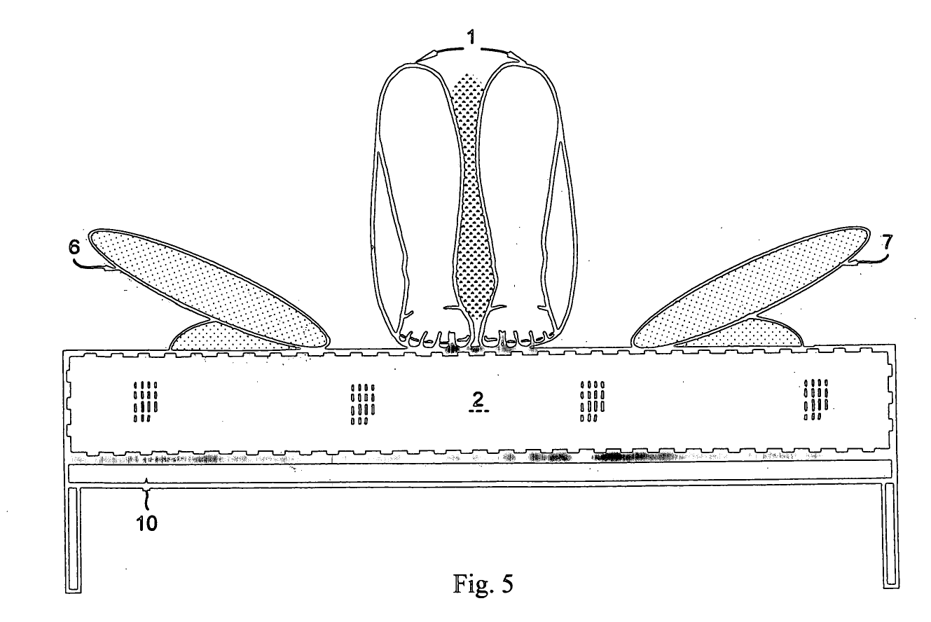

FIG. 5: The encased right and encased left knee inflatables [6 and 7] begin to inflate and are shown one-quarter inflated.

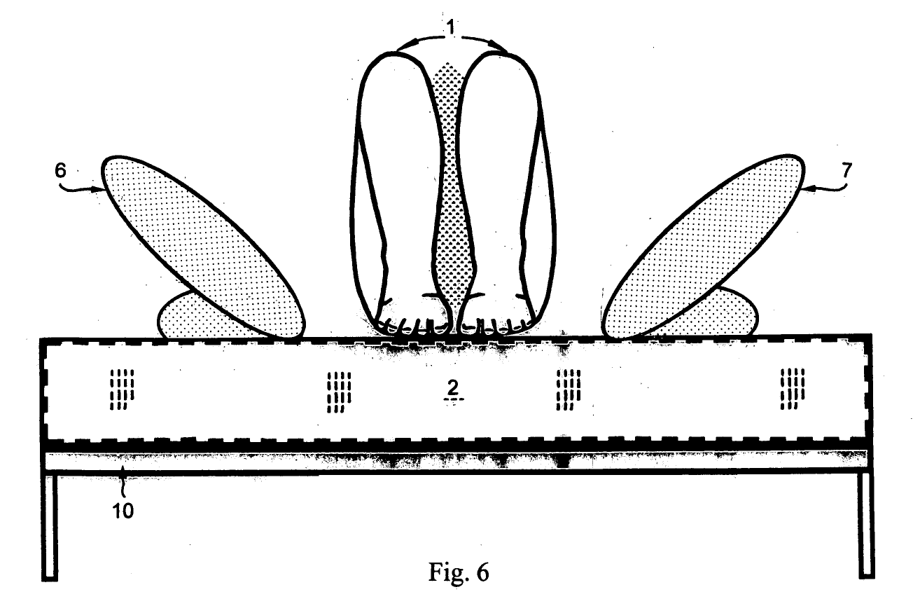

FIG. 6: The encased right and encased left knee inflatables [6 and 7] are shown half inflated.

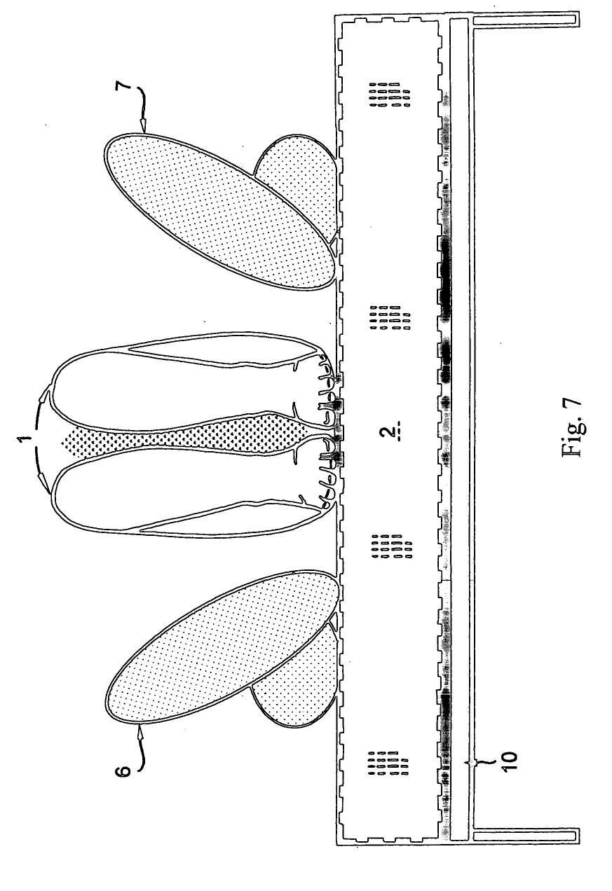

FIG. 7: The encased right and encased left knee inflatables [6 and 7] are shown three-quarters inflated.

FIG. 8: The encased right and encased left knee inflatables [6 and 7] are now fully inflated showing the bent knees [1] sandwiched between them in a perpendicular position.

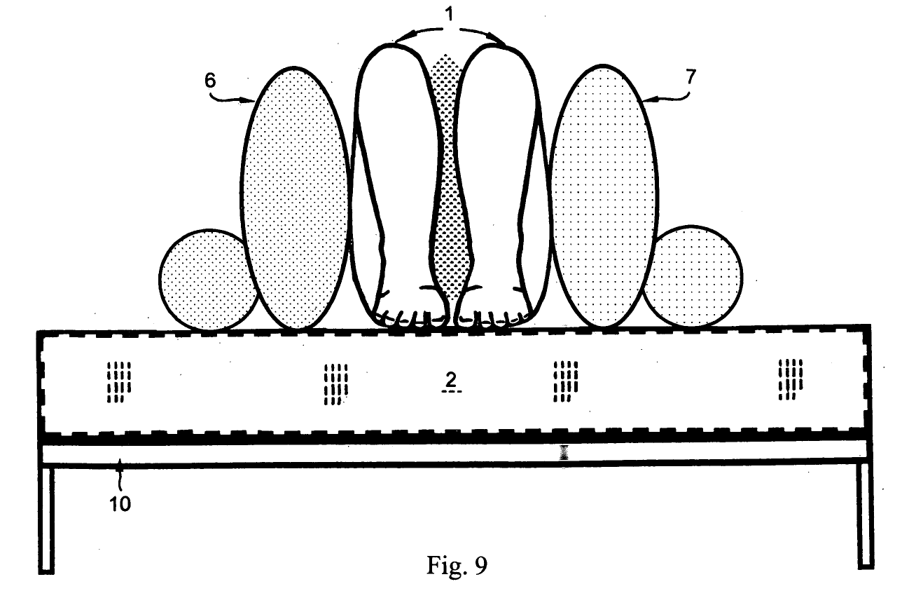

FIG. 9: The encased right knee inflatable [6] is still in the inflation mode, and the encased left knee inflatable [7] is now shown in the deflation mode.

FIG. 10: The right encased elongated inflatable [4] is one-third inflated showing the bent knees [1] having moved to the left due to the pressure exerted upon the knees by the fully inflated encased right knee inflatable [6] and the space provided for their descent by the gradually deflating encased left knee inflatable [7].

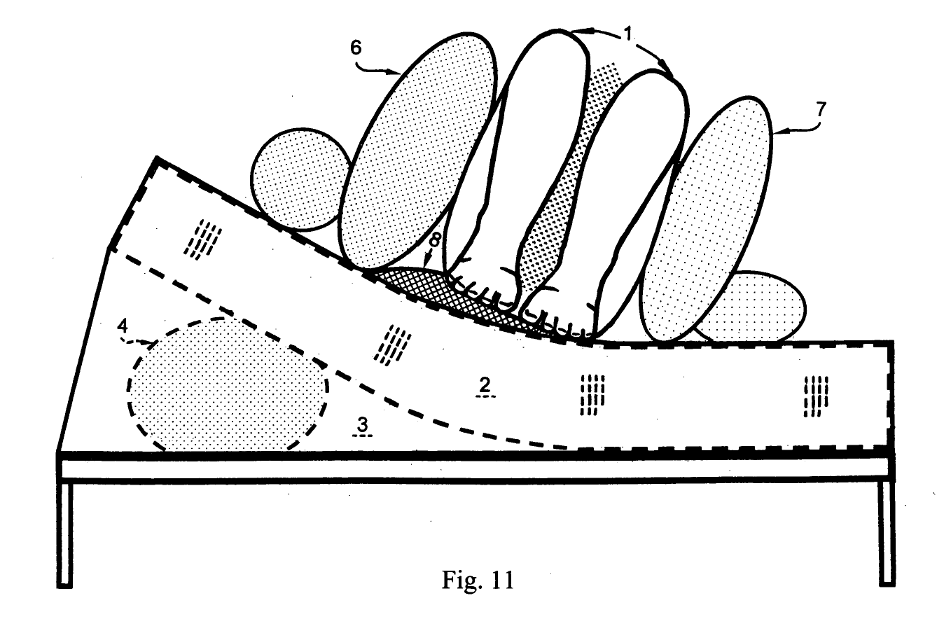

FIG. 11: The right encased elongated inflatable [4] is two-thirds inflated showing the bent knees [1] having moved further to the left, and the slowly inflating encased right back-support inflatable [8] is now visible.

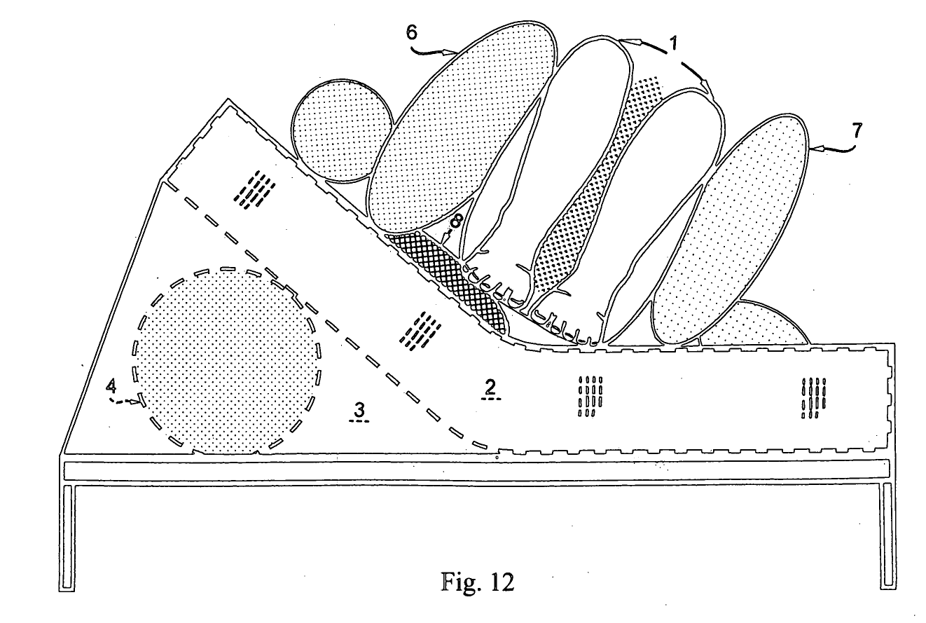

FIG. 12: The right encased elongated inflatable [4] is now fully inflated showing the bent knees [1] having moved 30 degrees left and beyond their initial perpendicular position.

FIG. 13: The right elongated inflatable [4] and the encased right and encased left knee inflatables [6 and 7], having brought the bent knees [1] to the point where they can descend on their own due to the force of gravity, are now in a deflation mode, and the encased right back-support inflatable [8] is now seen gradually inflating.

FIG. 14: The encased left knee inflatable [7] continues to deflate, allowing the bent knees [1] to further descend while the gradually inflating encased right back-support inflatable [8] continues to push the patient's back further to the left.

FIG. 15: The encased left knee inflatable [7] is seen almost fully deflated, allowing the bent knees [1] to fully descend aided by the pressure exerted upon the patient's back due to the encased right back-support inflatable [8] approaching full inflation.

FIG. 16: The patient has been fully turned to the left lying upon a flat mattress [2] with the fully inflated encased right back-support inflatable ‘pillow’ [8] lending support to the patient's back.

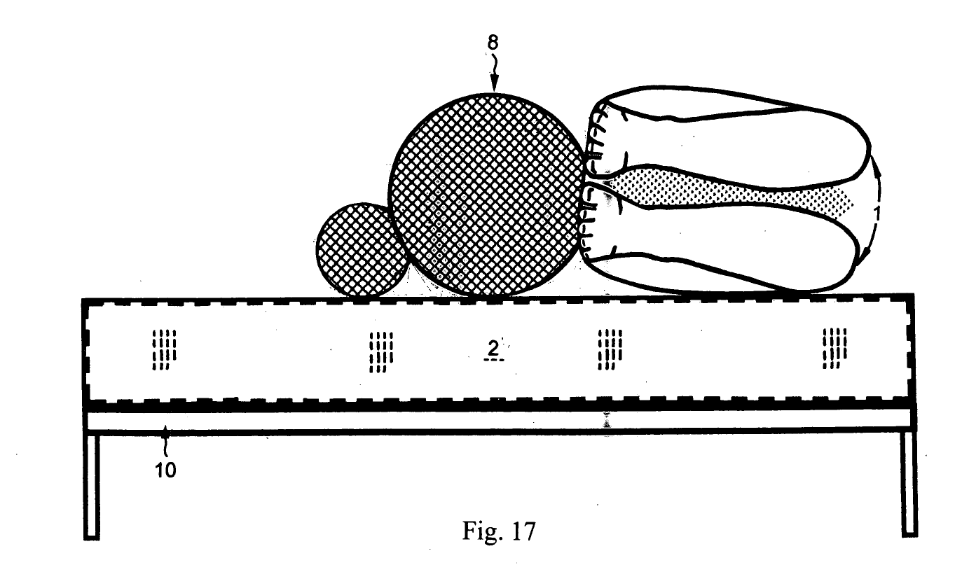

FIG. 17: The encased right back-support inflatable [8] is now shown in a deflation mode.

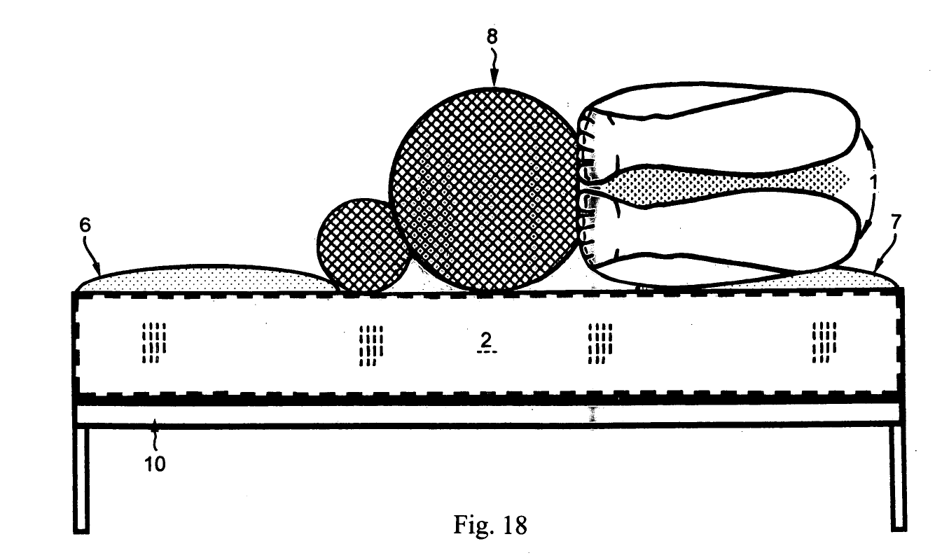

FIG. 18: The encased right and encased left knee inflatables [6 and 7] begin to inflate where the encased left knee inflatable [7] gradually raises the bent knees [1] of the patient and slowly turns them to the right as the encased right back-support inflatable [8] gradually deflates.

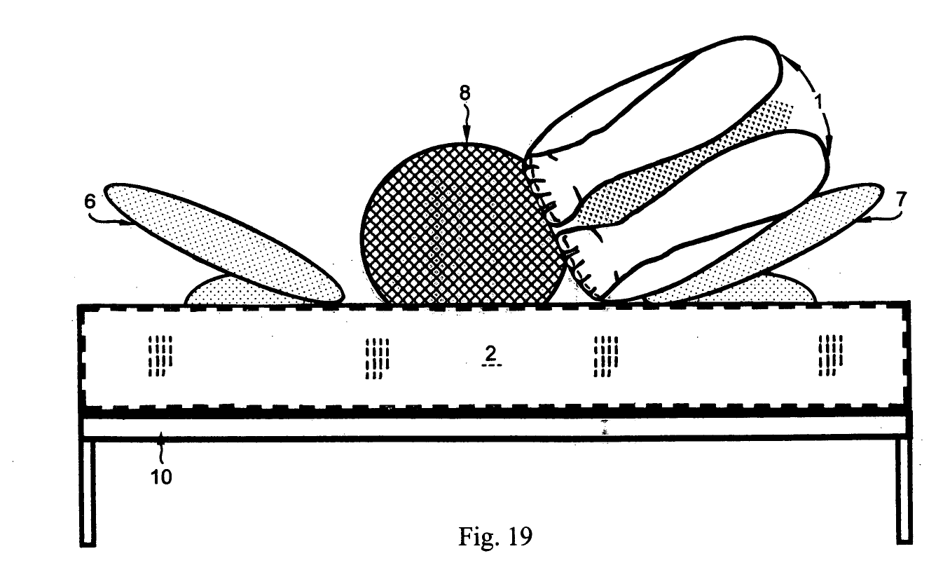

FIG. 19: The encased right and encased left knee inflatables [6 and 7] are shown one-fourth inflated where the encased left knee inflatable [7] has further raised the bent knees [1] in the direction of being turned to the right as the gradually deflating encased right back-support inflatable [8] provides space for the turn to the right.

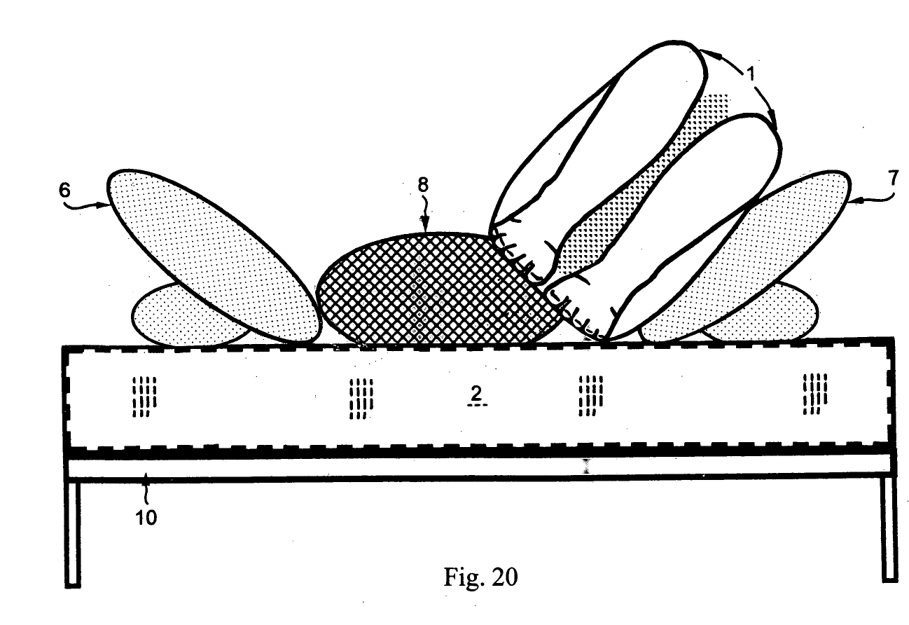

FIG. 20: The encased right and encased left knee inflatables [6 and 7] are shown one-half inflated where the encased left knee inflatable [7] has raised the bent knees [1] half way from their initial horizontal position to being perpendicular due to the space provided by the deflating encased right back-support inflatable [8].

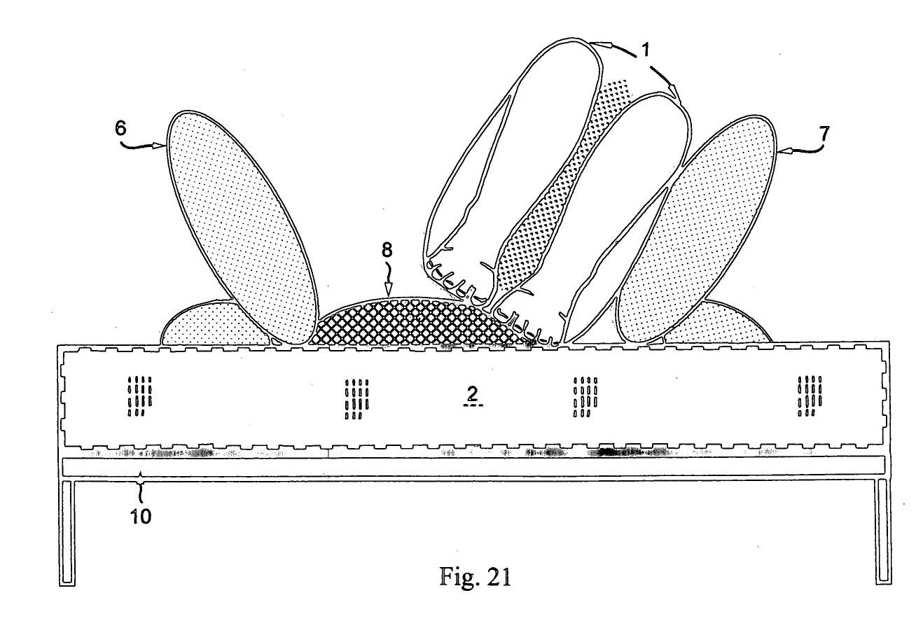

FIG. 21: The encased right and encased left knee inflatables [6 and 7] are shown three-quarters inflated where the encased left knee inflatable [7] has raised the bent knees [1] close to being in a perpendicular position as the encased right back-support inflatable [8] is in the final stages of deflation.

FIG. 22: The encased right and encased left knee inflatables [6 and 7] are now fully inflated showing the bent knees [1] sandwiched between them in a perpendicular position.

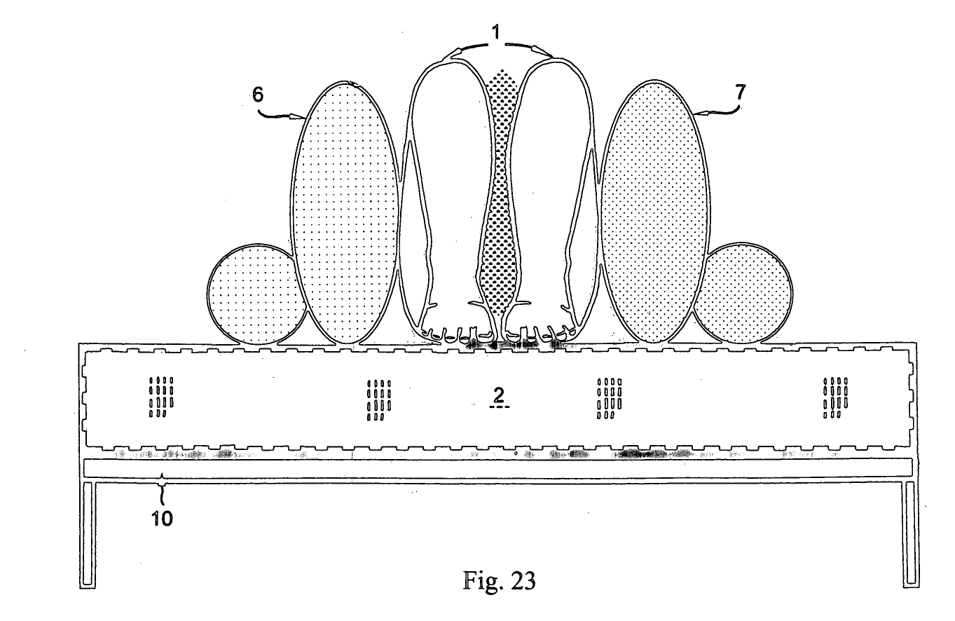

FIG. 23: The encased left knee inflatable [7] is still in the inflation mode, and the encased right knee inflatable [6] is now shown in a deflation mode.

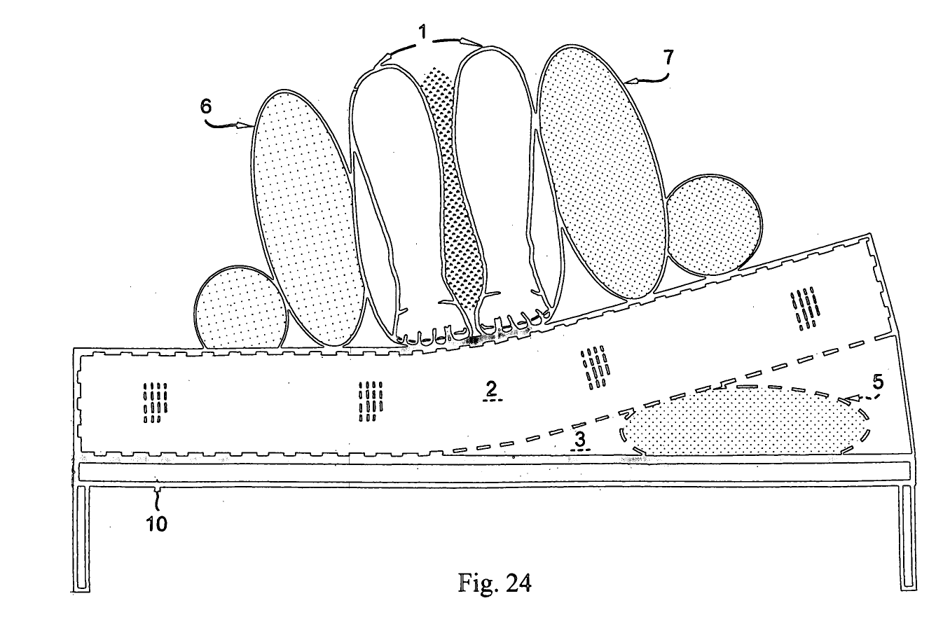

FIG. 24: The left elongated inflatable [5] is one-third inflated showing the bent knees [1] having moved to the right due to the pressure exerted upon the knees by the fully inflated encased left knee inflatable [7] and the space provided for their descent by the gradually deflating encased right knee inflatable [6].

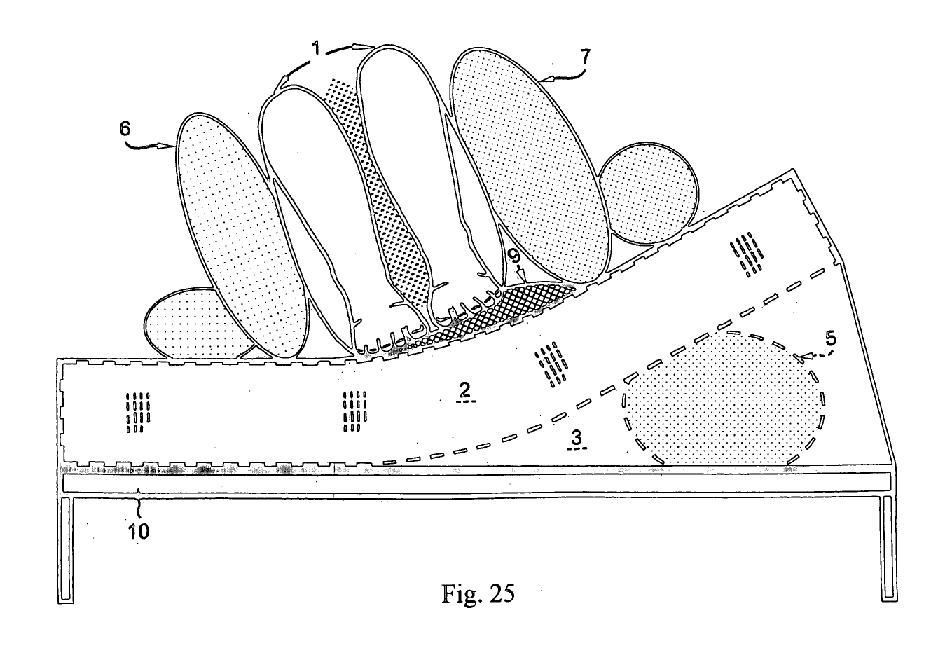

FIG. 25: The left elongated inflatable [5] is two-thirds inflated showing the bent knees [1] having moved further to the right, and the slowly inflating encased left back-support inflatable [9] is now visible.

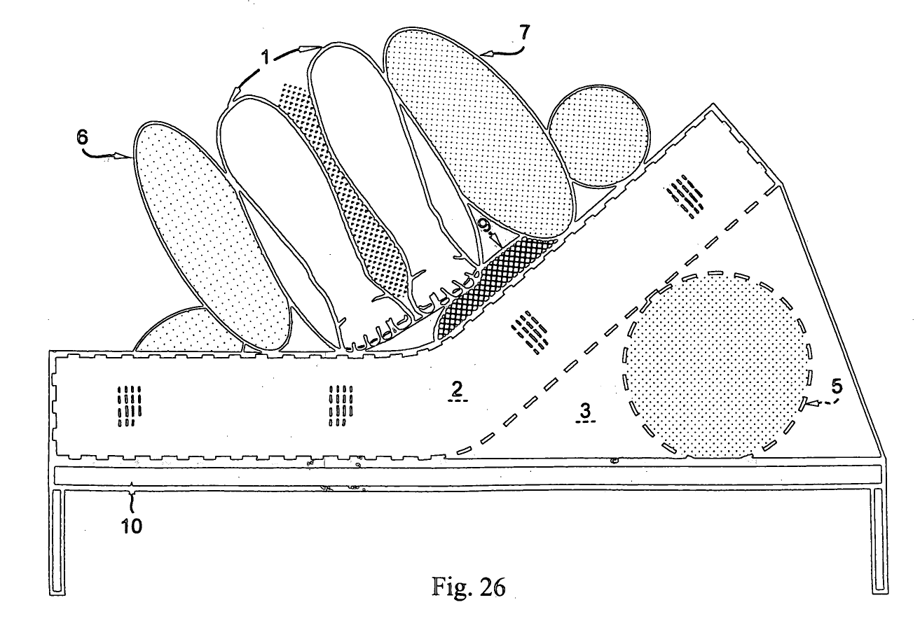

FIG. 26: The left elongated inflatable [5] is now fully inflated showing the bent knees [1] having moved 30 degrees right and beyond their initial perpendicular position.

FIG. 27: The left elongated inflatable [5] and the encased right and encased left knee inflatables [6 and 7], having brought the bent knees [1] to the point where they can descend on their own due to the force of gravity, are now in a deflation mode, and the encased left back-support inflatable [9] is now seen gradually inflating.

FIG. 28: The encased right knee inflatable [6] continues to deflate allowing the bent knees [1] to further descend while the gradually inflating encased left back-support inflatable [9] continues to push the patient's back further to the right.

FIG. 29: The encased right knee inflatable [6] is seen almost fully deflated allowing the bent knees [1] to approach a full descent aided by the pressure exerted upon the patient's back due to the encased left back-support inflatable [9] approaching full inflation.

FIG. 30: The patient is shown fully turned to the right lying upon a flat mattress [2] with the fully inflated encased left back-support inflatable ‘pillow’ [9] lending support to the patient's back.

### DETAILED DESCRIPTION OF THE INVENTION

Each stage of the turning process, beginning with FIG. 5, is represented by a static figure showing the end of that stage. A discussion of each subsequent figure will point out what changes took place since the previous figure. The discussion will include not only the changes in the inflation and deflation of the various inflatables, but also the effect those changes have in moving the bent knees [1] of the patient, and hence the patient, in the direction of the turn. The turning process involves several phases, each of which will be discussed in chronological order.

Preparing the patient for the automatic turn mode. Other than the periodic monitoring of the patient, the assistance of a nurse or caregiver is necessary only with the commencing and terminating of the automatic turning mode. Prior to the start of the turning process, the patient must be placed along the longitudinal center of the encased flexible mattress assembly. The arms of the patient are to be folded and placed upon the chest. To demonstrate how the invention will automatically turn a patient, and in this illustration it will be an initial turn to the left, the nurse or caregiver must press the automatic turn push button, and then the left turn push button; both are on the control panel.

The bent knees are to be sandwiched between a pair of knee inflatables. When the automatic turn and left turn push buttons are pressed, the encased right knee and encased left knee inflatables [6 and 7] begin to gradually inflate. The nurse or caregiver must now raise and bend the knees of the patient to form the apex of an inverted ‘V’ and place a pillow between the knees and legs; see FIG. 4. The bent knees [1] are to be held in a perpendicular position by the nurse or caregiver until the encased right and encased left knee inflatables [6 and 7] are fully inflated. The inflation of the two encased knee inflatables [6 and 7] is shown in FIG. 5 through FIG. 7 at various stages of inflation: one-quarter, one-half, and then three-quarters inflated, respectively.

When, in FIG. 8, the two encased knee inflatables [6 and 7] are fully inflated, it is no longer necessary for the nurse or caregiver to hold the bent knees [1] of the patient in place because the bent knees [1] are now ‘locked in place’ in a perpendicular position by being sandwiched between the two fully inflated encased knee inflatables [6 and [7].

Preparing the bent knees to move left from being perpendicular. In preparing the patient to move left from being in a perpendicular position, the encased right knee inflatable [6] remains fully inflated while the encased left knee inflatable [7] changes from an inflation to a deflation mode; see FIG. 9.

Moving the bent knees to the left from being perpendicular. The bent knees [1] gradually move to the left as the right longitudinal side of the flexible mattress [2] begins to rise slowly due to the gradual inflation of the encased right elongated inflatable [6] located beneath the right longitudinal side of the flexible mattress [2]. In FIG. 10, the right longitudinal side of the mattress is on a 25° incline when the encased right elongated inflatable [4] is one-third inflated. As the right longitudinal side of the flexible mattress [2] gradually rises, the fully inflated encased right knee inflatable [6] exerts pressure on the bent knees [1] that are sandwiched between the encased knee inflatables [6 and 7]. The encased left knee inflatable [7] continues to deflate making room for the bent knees [1] to descend. Though not visible in the figure, the encased right back-support inflatable [8] also begins to inflate.

Moving the bent knees further to the left. As the right elongated inflatable [4] continues to inflate, it causes the right longitudinal side of the flexible mattress [2] to be on an even greater incline. The greater the incline, the more the encased knee inflatables [6 and 7] move further to the left. Since the bent knees [1] are sandwiched between the two encased knee inflatables [6 and 7], they not only move further to the left, but they also descend in the direction of the turn as the encased left knee inflatable [7] deflates. The inflation of the encased right back-support inflatable [8] is now visible. Its purpose is to ensure that while the patient is being turned to the left, the back of the patient is on the same incline as the bent knees [1]. In FIG. 11, the right encased elongated inflatable [4] is two-thirds inflated.

The slope of the right side of the flexible mattress has reached its maximum. When the right elongated inflatable [4] is fully inflated, the slope of the right longitudinal side of the flexible mattress [2] has reached its maximum incline. The fully inflated encased right knee inflatable [6] and the inflating encased right back-support inflatable [8] jointly push the bent knees and the back of the patient 30 degrees to the left from its initial perpendicular position; see FIG. 12.

The right encased elongated inflatable [4] and the encased right knee inflatable [6] have fulfilled their function of moving the bent knees [1] 120 degrees from the right longitudinal side of the flexible mattress [2] when it was in a horizontal position. Therefore, both the encased right elongated inflatable [4] and the encased right knee inflatable [6] are ready to deflate; see FIG. 13.

The bent knees are in the process of fully descending. The gradual inflation of the encased right back-support inflatable [8] continues to push the back of the patient as well as the entire body of the patient even further in the direction of the turn. This is to ensure that the back will remain on the same degree of incline as the bent knees [1] that are descending due to the deflation of the encased left knee inflatable [7] and the force of gravity. During the descent, the entire body of the patient is pulled to the left; see FIG. 14.

In FIG. 15, as the encased left knee inflatable [7] approaches total deflation, the bent knees [1] are in the final stages of descending. This really means that the entire body of the patient is in the final stages of being turned to the patient's left side. The encased right back-support inflatable [8], approaching full inflation, will then serve as a ‘pillow’ lending support to the back.

The patient has been fully turned to the left side. With the complete deflation of the encased right elongated inflatable [4], the right longitudinal side of the flexible mattress [2] has returned to its original horizontal position. The patient has now been turned in a manner similar to the manual turning by a nurse or caregiver. The patient is lying on his or her left side upon a horizontal flexible mattress [2] with a pillow between the bent knees [1] and legs, and the fully inflated encased right back-support inflatable [8] serving as a ‘pillow’ lending support to the patient's back; see FIG. 16.

Returning the bent knees to a perpendicular position. After approximately one hour, it is time for the patient to be automatically turned to the right side by the bent knees [1] being raised from a horizontal to a perpendicular position. This is accomplished by coordinating the deflation of the encased right back-support inflatable [8] with the inflation of both the encased right and encased left knee inflatables [6 and 7]. In FIG. 17, the encased right back-support inflatable [8] is now ready to deflate.

Shown in FIG. 18 to FIG. 22 is the process of raising the bent knees [1] from a horizontal to a perpendicular position by the coordinated deflation of the encased right back-support inflatable [8] with the inflation of the encased right and encased left knee inflatables [6 and 7]. It is really only the encased left knee inflatable [7] that actually raises the bent knees [1]. The coordination of these two pneumatic processes is seen in FIG. 18 to FIG. 22 by showing five stages in the inflation of the encased right and encased left knee inflatables [6 and 7] in the following order: slightly inflated, one-fourth inflated, half inflated, three-quarters inflated, and then fully inflated. When fully inflated, the bent knees [1] are ‘locked in place,’ sandwiched between the two encased knee inflatables [6 and 7].

Preparing the bent knees to move right from being perpendicular. In preparing the patient to move right from being in a perpendicular position, the encased left knee inflatable [7] remains fully inflated while the encased right knee inflatable [6] changes from an inflation to a deflation mode; see FIG. 23.

Moving the bent knees to the right from being perpendicular. The bent knees [1] gradually move to the right as the left longitudinal side of the flexible mattress [2] begins to rise slowly due to the gradual inflation of the encased left elongated inflatable [7] located beneath the left longitudinal side of the flexible mattress [2]. In FIG. 24, the left longitudinal side of the mattress is on a 25° incline when the encased left elongated inflatable [5] is one-third inflated. As the left longitudinal side of the flexible mattress [2] gradually rises, the fully inflated encased left knee inflatable [7] exerts pressure on the bent knees [1] that are sandwiched between the encased knee inflatables [6 and 7]. The encased right knee inflatable [6] continues to deflate making room for the bent knees [1] to descend. Though not visible in the figure, the encased left back-support inflatable [9] also begins to inflate.

Moving the bent knees further to the right. As the left elongated inflatable [5] continues to inflate, it causes the left longitudinal side of the flexible mattress [2] to be on an even greater incline. The greater the incline, the more the encased knee inflatables [6 and 7] move further to the right. Since the bent knees [1] are sandwiched between the two encased knee inflatables [6 and 7], they not only move further to the right, but they also descend in the direction of the turn as the encased right knee inflatable [6] deflates. The inflation of the encased left back-support inflatable [9] is now visible. Its purpose is to ensure that while the patient is being turned to the right, the back of the patient is on the same incline as the bent knees [1]. In FIG. 25, the encased left elongated inflatable [5] is two-thirds inflated.

The slope of the left side of the flexible mattress has reached its maximum. When the left elongated inflatable [5] is fully inflated, the slope of the left longitudinal side of the flexible mattress [2] has reached its maximum incline. The fully inflated encased left knee inflatable [7] and the inflating left back-support inflatable [9] jointly push the bent knees and the back of the patient 30 degrees to the right from its initial perpendicular position; see FIG. 26.

The encased left elongated inflatable [5] and the encased left knee inflatable [7] have fulfilled their function of moving the bent knees [1] 120 degrees from the left longitudinal side of the flexible mattress [2] when the mattress was in a horizontal position. Therefore, both the encased left elongated inflatable [5] and the encased left knee inflatable [7] are ready to deflate; see FIG. 27.

The bent knees are in the process of fully descending. The gradual inflation of the encased left back-support inflatable [9] continues to push the back of the patient as well as the entire body of the patient even further in the direction of the turn. This is to ensure that the back will remain on the same degree of incline as the bent knees [1] that are descending due to the deflation of the encased right knee inflatable [6] and the force of gravity. During the descent, the entire body of the patient is pulled to the right; see FIG. 28.

In FIG. 29, as the encased right knee inflatable [6] approaches total deflation, the bent knees [1] are in the final stages of descending. This really means that the entire body of the patient is in the final stages of being turned to the patient's right side. The encased left back-support inflatable [9], approaching full inflation will then serve as a ‘pillow’ lending support to the back.

The patient has been fully turned to the right side. With the complete deflation of the encased left elongated inflatable [5], the left longitudinal side of the flexible mattress [2] has returned to its original horizontal position. The patient has now been turned in a manner similar to the manual turning by a nurse or caregiver. The patient is lying on his or her right side upon a horizontal flexible mattress [2] with a pillow between the bent knees [1] and legs, with a fully inflated encased left back-support inflatable [9] serving as a ‘pillow’ lending support to the patient's back; see FIG. 30.

After lying on his or her right side for approximately an hour, the patient will then be automatically turned to the left. To accommodate the comfort level of patients of varying size, the pressure in the back-support inflatable ‘pillows’ [8 and 9] can be adjusted. The automatic turning cycle will continue hourly until the nurse or caregiver presses the flat push button. To complete the entire turning cycle, it would be necessary to include an additional phase: ‘Preparing the bent knees to move left from a horizontal to a perpendicular position.’ The initial stage in the turning process begins with the patient's bent knees already placed in a perpendicular position. Consequently, there are no drawings showing the patient being turned from lying on the right side to the position where the bent knees [1] are in a perpendicular position. These drawings are not shown; however, they are mirror images of FIG. 18 to FIG. 22.

Terminating the automatic turn mode: To terminate automatic turning, the nurse or caregiver is to press the flat push button on the control panel. Any inflated encased elongated inflatable [4 or 5] and any inflated encased back-support inflatable [8 or 9] will then deflate. At the same time, the encased knee inflatables [6 and 7] are to remain inflated or brought to full inflation. In the end, the patient will lie upon the encased flexible mattress [2] that is now horizontal, with the bent knees [1] sandwiched in a perpendicular position between the two fully inflated encased knee inflatables [6 and 7].

Once the preceding operations are completed, the light in the reset push button will blink alerting the nurse or caregiver to read the message on the display with a reminder to lower the bent knees [1] of the patient. To ensure that this responsibility is performed, the nurse or caregiver is to acknowledge the message by pressing the reset push button and then lower the bent knees [1] of the patient to a flat position. After two minutes, the light in the reset push button will blink a second time. This is to verify that the nurse or caregiver did not leave the area without having lowered the patient's bent knees. Pushing the reset push button a second time will then terminate the blinking. If the reset push button is not pressed a second time within a three-minute period, beeping will alert the nurse or caregiver with a warning message to lower the patient's knees. Should the patient remain lying in a flat position for more than one hour, the light in the reset push button will blink, and a message on the display will alert the nurse or caregiver that it is time to turn the patient. If the reset push button is not pressed with ten minutes, the beeper will sound.

Additional Features

Tilting the patient: At times, patient care will require that the patient lie on an incline. In addition to automatic turning, there is the option of tilting the patient to a maximum of a 30° angle by first pressing the non-automatic push button and then either the right tilt or left tilt push button. It will also be possible to increase or decrease the slope of the incline. Should the patient remain on an incline for more than one hour, the sound of the beeper and the light in the reset push button will blink alerting the nurse or caregiver to read the message on the display that it is time to turn the patient.

The non-automatic turn mode: When tubes or wires are attached to the body of the patient, the automatic mode must not be used; otherwise, there is the possibility that the tubes or wires may get tangled. In the event tubes or wires are attached to the body of the patient, it is still possible, if not advisable, to turn the patient using the non-automatic mode. In the non-automatic mode, the patient can only be turned once each time the nurse or caregiver presses the non-automatic turn push button and then either the right turn or left turn push button. The nurse or caregiver must be present to monitor the turn and to adjust the tubing or wires in the event they get tangled. Especially in the non-automatic mode, the turning of a patient with wires or tubing attached to the patient's body is a very serious responsibility on the part of the nurse or caregiver. To verify that the nurse or caregiver did not leave the area, as soon as the single turn is completed, there will be a single beep and the light in the reset push button will blink for ten seconds. The nurse or caregiver will have a three-minute period to make any necessary adjustments. After a 90-second delay, the nurse or caregiver is to press the reset push button before the three-minute period ends; otherwise, the warning beeper will sound with a reminder message on the display. The 90-second delay is to ensure that the nurse or caregiver is in the area to monitor the turn and make any necessary adjustments.

The Unique Advantages of the Automatic Patient Turner

At the time this application is being submitted, no device has been patented or on the market that will laterally turn an immobile patient automatically, and periodically along the longitudinal axis of a bed from one side to the other in a manner similar to and equally effective as the manual turning by a nurse or caregiver. It is highly unlikely that a patient who is gently turned hourly from one complete side to the other will ever develop a pressure sore. Automatic turning is significantly less abrasive and less intrusive than manual turning. The turn is slow, smooth, and so gentle that it will not even wake most sleeping patients, allowing for a full night of uninterrupted sleep.

It is tragic that millions of immobile patients worldwide are currently suffering from pressure sores since they are preventable if a patient is turned every two hours. This invention is not intended for the treatment of pressure sores once they develop. It is, however, the ultimate in pressure sore prevention. The Automatic Patient Turner can prevent the development of pressure sores in the highest risk category of patients. They are the millions of patients worldwide who are paralyzed stroke victims, spinal cord injury patients, and the very large numbers of elderly patients who are in the latter stages of dementia or Alzheimer's disease.

Aside from the humane aspects of this invention in preventing the development of pressure sores, the prevalence of pressure sores has an economic dimension that is immense. All of the estimates of the annual cost of treating pressure sores are in the billions of dollars. This is an unnecessary expenditure by the patient or the patient's family, insurance companies, health maintenance organizations and especially government social service agencies. Since most of the patients with pressure sores are disabled, elderly and of low income, a significant share of the cost of treatment is borne by government social service agencies. The one-time cost of providing an automatic patient turner to each immobile patient as an entitlement, is insignificant compared to the tremendous cost arising from not solving the problem of pressure sores once and for all.

There would also be a great saving in reducing the work load and staff hours of those who are responsible for turning an immobile patient every two hours at a long-term care nursing facility. Two staff members are often required to turn patients every two hours. Especially at night when patients are asleep, automatic patient turning could necessitate only one staff person to make the rounds every hour just to monitor patients. To document that patients are being monitored hourly, the person making the rounds is to press the monitor button on the control panel of each patient.

An automatic patient turning device will now make it feasible for a family to care for an immobile loved one at home. The burden of having to manually turn a patient is a major factor discouraging patient home care, especially when the number of caregivers at home is limited. The cost of patient home care is significantly less than the cost at a nursing facility. There would be a tremendous saving to families and again to government social service agencies that pay the cost of long-term patient care at nursing facilities. Finally, a patient's mental health would be enhanced if he or she could remain at home among family. A device that would allow patient care at home rather than at a nursing facility is currently the policy of government social service agencies that pay for the care of a patient at a long-term care nursing facility.

Automatic patient turning will also greatly decrease the probability of a nurse or caregiver developing back problems resulting from the periodic manual turning of heavy, immobile patients. This is currently a serious, unnecessary, and avoidable work-related hazard leading to pain, the loss of work time, including some employees being placed on disability. Again, there is an additional economic dimension to this problem in terms of worker's compensation and an increase in insurance rates paid by hospitals and nursing facilities. The automatic turning of patients is also in accord with the current government policy of using various mechanical devices in the moving and lifting of a patient, thereby precluding the nursing staff from having to perform those functions manually.

Safety Features

The care of an immobile patient is a grave responsibility on the part of the nursing staff or caregiver. It is for this reason that a warning system has been installed that will alert a nurse or caregiver whenever a patient remains in one position for more than one hour. To maximize accountability, a method of monitoring has also been incorporated into the system that can document the quality of patient care in areas that demand the assistance of a nurse or caregiver.

To detect any malfunction in the system itself, sensors have been incorporated. A diagnostic test will be performed each time the patient turner is turned on to verify that all of the parts are in working order. Any failure in the system will sound a warning buzzer, and the light in the reset push button will blink. The cause of the failure will appear on a display. The immediate identification of the part or parts that had caused the malfunction will lessen downtime. Furthermore, the system will be automatically monitored for a possible failure as long as the power switch is on.

In the event power to the unit has been accidentally disrupted, an auxiliary battery operated unit will automatically place the system into a flat mode. At the same time the sound of a beeper will alert the nurse or caregiver with a blinking light in the reset push button indicating that there is a message on the display.

Precautions

Though they are not shown in the drawings, padded side rails must be attached to the hospital bed unless a jurisdiction has prohibited their use. This patient turner is intended to be safe for general use by immobile patients. Nevertheless, the condition of each patient is unique; therefore, a label will be affixed on each device stating the following:
1) The Automatic Patient Turner should only be used by a patient upon the advice and written permission of the attending physician.
2) Unless prohibited, padded side rails should be attached to the hospital bed.
3) The automatic turn mode must never be used when wires or tubing are connected to the patient. It can be used in the non-automatic turn mode where each single turn will be monitored.

Obviously, numerous variations and modifications can be made without departing from the spirit and unique concepts of the present invention. Therefore, it should be clearly understood that the form of the present invention described above and shown in the figures of the accompanying drawings is illustrative only and is not intended to limit the scope of the present invention.

1. An encased flexible mattress assembly placed on the top of a hospital bed [10] designed to prevent pressure sores and the accumulation of fluid in the lungs by repositioning an immobile patient by first tilting laterally, automatically, alternately, and periodically, and then gently turning the patient laterally from one complete side to the other along a generally longitudinal axis of the said encased flexible mattress assembly and hospital bed [10] comprising:
an encased flexible mattress [2] having a generally longitudinal axis where within a chamber [3] beneath said flexible mattress [2], on its right longitudinal side, at least one encased right elongated inflatable [4] raises and lowers the right longitudinal side of said encased flexible mattress [2] relative to the longitudinal axis of said flexible mattress assembly, and within said chamber [3] beneath said flexible mattress [2], on its left longitudinal side, at least one encased left elongated inflatable [5] raises and lowers the left longitudinal side of said encased flexible mattress [2] relative to the longitudinal axis of said encased flexible mattress assembly, alternatively tilting the patient as the first phase of a turning process.

2. The encased flexible mattress assembly defined in claim 1 further comprising:
at least one encased knee inflatable [6] attached to the top of the said encased flexible mattress assembly positioned on the outer right side of the patient's bent knees [1] when lying longitudinally upon the said encased flexible mattress assembly and at least one encased knee inflatable [7] attached to the top of the said encased flexible mattress assembly positioned on the outer left side of the patient's bent knees [1] when lying longitudinally upon said encased flexible mattress assembly, where said bent knees [1], acting as a lever arm when sandwiched between said encased right and encased left knee inflatables [6 and 7] can laterally turn the patient alternately to lie on each side as a result of the patterned inflation and deflation of said encased right and encased left knee inflatables [6 and 7] in conjunction with the raising and lowering of each longitudinal side of the encased flexible mattress [2] due to the alternate inflation and deflation of the said encased right and said encased left elongated inflatables [4 and 5] cited in claim 1 culminating in the patient lying upon the horizontal surface of the said encased flexible mattress assembly with a pillow between the patient's bent knees and legs.

3. The encased flexible mattress assembly defined in claims 1 and 2 further comprising:
at least one encased back-support inflatable [8] attached to the top of said encased flexible mattress assembly positioned at the right side of the patient's back when lying longitudinally upon said encased flexible mattress assembly, and at least one encased back-support inflatable [9] attached to the top of said encased flexible mattress assembly positioned at the left side of the patient's back when lying longitudinally upon said encased flexible mattress assembly, where the patterned and sequential inflation and deflation of at least one alternate back-support inflatable [8 or 9] in conjunction with the patterned and sequential inflation and deflation of the encased knee inflatables [6 and 7] cited in claim 2 will assist in moving the patient in the direction of the turn in addition to lending support to the back of the patient during and following the turning process.
